(19) United States
(12) Patent Application Publication
(10) Pub. No.: US 2005/0230239 A1
(43) Pub. Date: Oct. 20, 2005

(54) Accelerating the discovery of effective photonic reagents

(76) Inventor: Herschel Rabitz, Lawrenceville, NJ (US)

Correspondence Address: COOPER & DUNHAM, LLP, 1185 AVENUE OF THE AMERICAS, NEW YORK, NY, 10036, US

(21) Appl. No.: 11/078,792

(22) Filed: Mar. 11, 2005

Related U.S. Application Data
(60) Provisional application No. 60/552,684, filed on Mar. 12, 2004.

(51) Int. Cl. C01B 3/00; C07B 31/00

(52) U.S. Cl. 204/157.41; 204/157.61

(57) ABSTRACT

A method for accelerating searches for optimal control of photonic reagents is provided. Closed loop feedback is applied to control a quantum system. A direct search deterministic technique is used for refining said closed loop feedback control. A quantum system controller is also provided.

This application claims the benefit of U.S. Provisional Application Ser. No. 60/552,684, filed Mar. 12, 2004, the entire contents of which are herein incorporated by reference.

This invention has been made with government support under NSF grant CHE-0107803, ARO-MURI grant DAAD19-01-1-0560, and DOE grant DE-FG02-02ER15344. Accordingly, the U.S. Government has certain rights in the invention.

A list of publications may be found in the References section immediately preceding the claims. The disclosures of these publications are hereby incorporated by reference in their entireties into this application in order to more fully describe the state of the art to which this application pertains.

### FIELD

The present disclosure relates to photonic reagents and, more specifically, to accelerating the discovery of effective photonic reagents.

### BACKGROUND

Laser pulses may be used to trigger changes in matter. For example, shaped laser pulses may be applied to compositions of matter to influence or trigger chemical reactions or changes in quantum state. The shape of the laser pulse may be altered to optimize the desired effect. An optimized laser pulse may therefore be an effective photonic reagent.

Determining the effective photonic reagent for a given quantum system has traditionally been a very difficult and/or time consuming process. It can be exceedingly difficult to accurately solve Schrodinger's equation on a computer to determine an effective photonic reagent. Laser pulse shaping tools guided by special algorithms may be used to modify the laser pulse shape as it is applied to a quantum system to discover effective photonic reagents. Shaped laser pulses may be used as photonic reagents in assorted applications, such as selective chemical bond breaking, the creation of high intensity high harmonic optical sources, creation of ultrafast optical switches, the manipulation of electron transfer in biological samples, the creation of tailored excitations in molecules and materials, etc. Each of these applications involves the use of closed loop adaptive feedback techniques guided by pattern recognition algorithms to meet the posted objectives. A great premium is placed on accelerating this feedback process to increase its efficiency by reducing the time, materials, and the expense of carrying out experiments to find effective photonic reagents.

Current experimental approaches employ expensive genetic type algorithms largely motivated by the belief they are needed to broadly search for effective photonic reagents. However, genetic techniques are often slow and resource consuming.

There is a need for an efficient, improved technique to accelerate the discovery of effective photonic reagents.

### SUMMARY OF THE INVENTION

The present disclosure provides methods and apparatuses for optimally controlling photonic reagents.

A method for accelerating searches for optimal control of photonic reagents, according to one exemplary embodiment, includes applying closed loop feedback to control a quantum system and using a direct search deterministic technique for refining said closed loop feedback control.

A quantum system controller for optimally controlling photonic reagents. The quantum system controller includes a closed loop feedback controller for applying closed loop feedback to control a quantum system and a control refining module utilizing a direct search deterministic technique to refine said closed loop feedback control.

### BRIEF DESCRIPTION OF THE DRAWINGS

FIG. 1 is a flow chart showing a method for accelerating searches for optimal control of photonic reagents, according to one embodiment of the present disclosure.

FIG. 2 is a flow chart showing a method for accelerating searches for optimal control of photonic reagents, according to another embodiment.

FIG. 3 is a flow chart showing a method for accelerating searches for optimal control of photonic reagents, according to another embodiment.

FIG. 4 is a block diagram showing a quantum system controller for optimally controlling photonic reagents, according to an embodiment of the present disclosure.

FIG. 5 is a block diagram showing a quantum system controller for optimally controlling photonic reagents, according to another embodiment.

FIG. 6 is a chart illustrating the general behavior of the quantum optimal control landscape for the probability of making a transition from an initial quantum state to a final quantum state.

FIG. 7 is a chart illustrating results for μ=0.0 laser fluence weight, the simplex methodology.

FIG. 8 is a chart illustrating results for μ=0.0 laser fluence weight, GA technique.

FIG. 9 is a chart illustrating results for μ=0.1 laser fluence weight.

FIG. 10 is a chart illustrating results for μ=0.0 laser fluence weight, the simplex methodology.

FIG. 11 is a chart illustrating results for μ=0.0 laser fluence weight, GA technique.

FIG. 12 is a chart illustrating results for μ=0.0 laser fluence weight and no noise for the discrete descent methodology with step size h=ξ=(0.01, . . . , 0.01).

FIG. 13 is a chart illustrating generic cost function J(x) behavior with respect to a single variable x.

### DETAILED DESCRIPTION

In order to facilitate an understanding of the discussion which follows one may refer to S. Rice and M. Zhao, Optical Control of Molecular Dynamics, (John Wiley and Sons, New York 2000) for certain frequently occurring methodologies and/or terms which are described therein.

However, except as expressly provided herein, each of the following terms, as used in this application, shall have the meaning set forth below.

As used herein, “closed loop feedback” shall refer to the technique of applying a reagent, monitoring a result and modifying the reagent based on the difference between the detected result and a desired result.

As used herein, “closed loop learning control technique” shall refer to the technique of applying a reagent, monitoring a result and modifying the reagent based on the difference between the detected result and a desired result, and based on modifications that have previously been successful.

As used herein, “direct descent methodology” shall refer to techniques for discovering an optimal setting by analyzing a series of quantum system settings related to one another by their proximity, where each subsequently analyzed quantum system setting is of increasing similarity to the optimal setting than the previously analyzed quantum system setting.

As used herein, “direct search deterministic techniques” shall refer to techniques for discovering an optimal setting for controlling a photonic reagent by analyzing a series of quantum system settings related to one another by their proximity.

As used herein, “discrete descent methodology” shall refer to techniques for discovering an optimal setting by analyzing proximal settings at predetermined spatial intervals.

As used herein, “frequency chirping techniques” shall refer to pulse compression or stretching techniques that use (usually linear) frequency modulation for the pulses.

As used herein, “functional evaluations” shall refer to computational techniques for refining feedback control.

As used herein, “guided control” shall refer to techniques for discovering an optimal setting utilizing knowledge of the quantum system landscape.

As used herein, “hierarchical search methodology” shall refer to techniques for discovering an optimal setting using a search organized along hierarchical lattices in the parameter space.

As used herein, “high-dimensional searches” shall refer to techniques for analyzing settings in a quantum system landscape with multiple control variables.

As used herein, “high duty cycle” shall refer to the capability for quickly and efficiently analyzing a large number of settings.

As used herein, “local extrema” shall refer to a point of increased yield within the quantum system landscape that may not correspond to an optimal setting.

As used herein, “local search methodology” shall refer to techniques for discovering an optimal setting by analyzing settings that are proximal and within a specified space.

As used herein, “modified simplex methodology” shall refer to simplex methodologies (see discussion below) that have been modified to handle data that includes noise.

As used herein, “ordinal optimization” shall refer to techniques for discovering an optimal setting by using an ordering approach that aims to find the settings of the pulse shaper that belong to a particular percentile of all designs.

As used herein, “pattern recognition methodologies” shall refer to techniques for discovering an optimal setting by analyzing proximal settings according to an observed pattern.

As used herein, “photonic reagents” shall mean a source of energy that is applied to matter in order to bring about a change in that matter. For example, a laser pulse can be applied to matter in order to bring about a change in a quantum state of the matter.

As used herein, “quantum state” shall refer to a disposition of a quantum system that is permissible under the laws of quantum physics.

As used herein, “quantum system” shall mean a system of matter and/or energy that may be correctly described using quantum physics.

As used herein, “quantum system landscape” shall refer to the system observation as a function of the pulse shaper controls.

As used herein, “quasideterministic methodology” shall refer to a technique for discovering an optimal setting wherein an algorithmic optimization step has some random component in its logic.

As used herein, “shaped laser pulse” shall refer to a laser pulse with a particular phase-amplitude signature.

As used herein, “simplex methodology” shall refer to techniques for discovering an optimal setting by analyzing a set of N+1 points forming a nondegenerate geometrical object (that is, where none of the points forming the object are the same) in the N-dimensional space.

The following exemplary embodiments and discussions of theory and experimental simulations are set forth to aid in an understanding of the subject matter of this disclosure but are not intended to, and should not be construed to, limit in any way the invention as set forth in the claims which follow thereafter.

Recent years have seen accelerating activity in the creation of photonic reagents (for example, shaped laser pulses) as a means for manipulating matter with a host of applications including (but not limited to) selective chemical bond breading, the creation of high intensity high harmonic optical sources, creation of ultrafast optical switches, the manipulation of electron transfer in biological samples, the creation of tailored excitations in molecules and materials, etc. Each of these applications involves the use of closed loop adaptive feedback techniques guided by pattern recognition methodologies to meet the posed objectives. A great premium is placed on accelerating this feedback process to increase its efficiency by reducing the time, materials, and the expense of carrying out experiments to find effective photonic reagents. However, current experiments by others employ expensive genetic type algorithms largely motivated by the belief they are needed to broadly search for effective photonic reagents. As discussed below, the premise underlying this assumption is false. This disclosure demonstrates that far more efficient operational performance can be achieved by building on these observations. In particular, local search techniques guiding the machines (e.g., gradient or simplex methodologies) have the capability of being highly effective.

Current and expanding laboratory and instrumentation operations with photonic reagents can be enhanced with the methodologies discussed in this disclosure to accelerate the experiments. Additional applications involving lengthy searches for effective photonic reagents are practicable with the techniques of this application.

By recognizing the true nature of the photonic reagent search spaces (discussed below), the currently applied global search techniques in the laboratory are not necessary for effective operations. The techniques of this application do not require fundamentally altering the laboratory apparatus, but rather the change is in the master methodologies and software guiding the machine operation involved. This feature facilitates ready transfer and utilization of the technology for widespread operations.

The methodologies of this application can be implemented as a component directing the operations of highly complex laser pulse shaping apparatus. Without a process directing the apparatus, the machines are not functional. Accelerating the performance of these machines in many cases can enable applications which heretofore were impractical. The process can also operate in the presence of significant laboratory noise and still maintain robust performance of the laser pulse shaping machines.

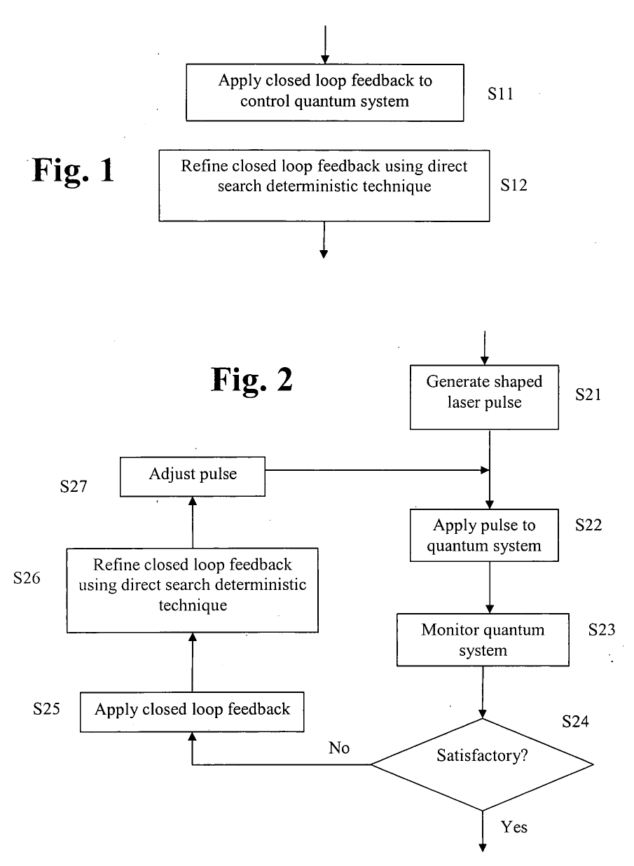

A method for accelerating searches for optimal control of photonic reagents, according to one embodiment of the present disclosure, is discussed below with reference to FIG. 1. Closed loop feedback is applied to control a quantum system (Step S11). The closed loop feedback control is refined by using a direct search deterministic technique (Step S12).

A method for accelerating searches for optimal control of photonic reagents according to another exemplary embodiment is discussed with reference to FIG. 2. A shaped laser pulse is generated (Step S21), and then applied to a quantum system (Step S22). The quantum system is monitored after the shaped laser pulse is applied (Step S23). If the quantum system is not performing in a satisfactory manner (Step S24, “NO”), closed loop feedback is applied to control the quantum system (Step S25). The closed loop feedback control is refined by using a direct search deterministic technique (Step S26). The shaped laser pulse is adjusted (Step S27), and then the adjusted pulse is applied to the quantum system (Step S22)

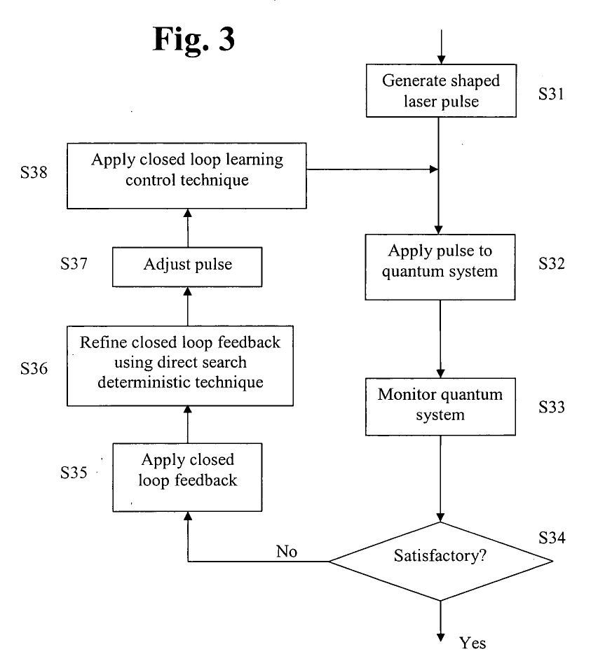

A method for accelerating searches for optimal control of photonic reagents, according to another embodiment (FIG. 3), can include the following steps. A shaped laser pulse is generated (Step S31), and then applied to a quantum system (Step S32). The quantum system is monitored after the shaped laser pulse is applied (Step S33). If the quantum system is not performing in a satisfactory manner (Step S34, “NO”), closed loop feedback is applied to control the quantum system (Step S35). The closed loop feedback control is refined by using a direct search deterministic technique (Step S36). The shaped laser pulse is adjusted (Step S37), and a closed loop learning technique is applied (Step S38). Subsequently, the adjusted pulse is applied to the quantum system (Step S32) and the control loop is repeated.

It should be apparent to one skilled in the art that the order of the steps need not be limited to the order as described above and shown in the figures. For example, steps S35-S38 can be applied in various different.

In addition, the methodologies may include other optional features, discussed below.

For example, frequency chirping techniques may be used for generating the shaped laser pulse.

The shaped laser pulse generated by utilizing the methodologies of this disclosure may be applied to the quantum system for any one or more of the following applications: to transition the quantum system from an initial quantum state to a desired final quantum state; to manipulate matter within the quantum system; to trigger selective breaking of chemical bonds; to trigger molecular vibration excitation within the quantum system; to enhance radiative high harmonics; to generate high intensity high harmonic optical sources; to implement ultrafast semiconductor optical switches; to trigger ultrafast semiconductor optical switches; to create tailored excitation in molecules; to trigger tailored excitation in solid state matter.

In addition, the shaped laser pulse may be applied to the quantum system to trigger an electron transfer in biological samples. The biological samples may include photosynthetic antenna complexes.

Mass spectrometry may be utilized to monitor the quantum system for selective fragmentation of the sample.

A direct descent methodology or discrete descent methodology may be utilized in addition to the direct search deterministic technique to refine the closed loop feedback control. The discrete descent methodology may use a Monte Carlo technique. The direct search deterministic technique may be guided by pattern recognition methodologies.

The direct search deterministic technique may include applying one or more of the following techniques: a local search methodology; a hierarchical search methodology; ordinal optimization; a simplex methodology; a modified simplex methodology; a quasideterministic methodology; guided control over a quantum system landscape. The quantum system landscape may be without substantial local extrema.

The direct search deterministic technique may include one or more of the following features: utilize functional evaluations for refining the closed loop feedback control; exploit a high duty cycle in refining the closed loop feedback control; robustness with respect to noise; avoid being trapped in a local extremum; perform high-dimensional searches.

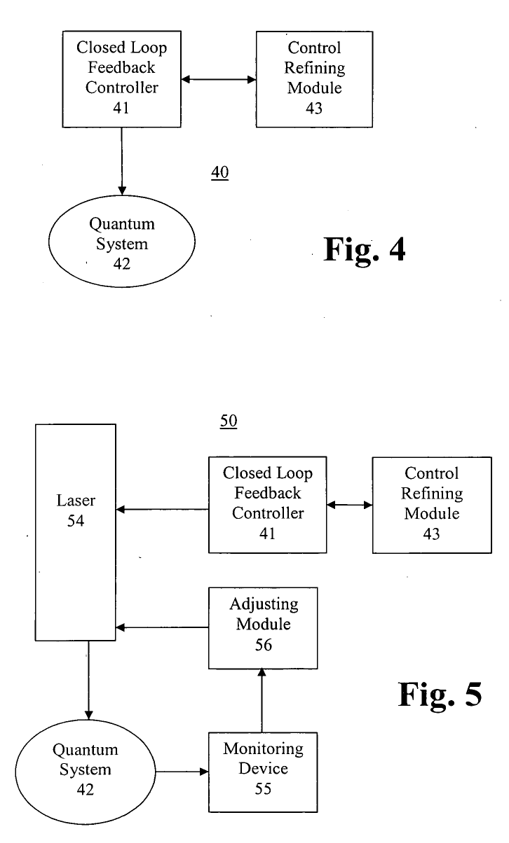

A quantum system controller for optimally controlling photonic reagents, according to an embodiment of the present disclosure, is discussed below with reference to FIG. 4. Quantum system controller 40 includes a closed loop feedback controller 41 for applying closed loop feedback to control a quantum system 42. The quantum system controller 40 also includes a control refining module 43 which utilizes a direct search deterministic technique to refine the closed loop feedback control.

According to another embodiment (FIG. 5), a quantum system controller 50 for optimally controlling photonic reagents includes in addition to the closed loop feedback controller 41 and the control refining module 43, a monitoring device 55 for monitoring the quantum system after a shaped laser pulse from a laser source 54 is applied to the quantum system 42, and an adjustment module 56 for adjusting the shaped laser pulse based on a result of the monitoring. The monitoring device can include, for example, a mass spectrometer.

The quantum system controller 41 may control the shaped laser pulse applied to the quantum system for any one or more of the following applications: to transition said quantum system from an initial quantum state to a desired final quantum state; to manipulate matter within said quantum system; to trigger selective breaking of chemical bonds; to trigger molecular vibration excitation within the quantum system; to enhance radiative high harmonics; to generate high intensity high harmonic optical sources; to implement ultrafast semiconductor optical switches; to trigger ultrafast semiconductor optical switches; to trigger an electron transfer in biological samples (for example, the biological samples may include photosynthetic antenna complexes); to trigger tailored excitation in molecules; to trigger tailored excitation in solid state matter.

The control refining module may use random values in the direct search deterministic technique for refining the closed loop feedback control, and/or utilize a direct descent methodology or a discrete descent methodology, in addition to the direct search deterministic technique, to refine the closed loop feedback control. The discrete descent methodology may use a Monte Carlo technique. The control refining module may utilize pattern recognition methodologies to guide the direct search deterministic technique.

The control refining module may apply a closed loop learning control technique and/or one or more of the following methodologies in the direct search deterministic technique: a local search methodology; a hierarchical search methodology; ordinal optimization; a simplex methodology; a modified simplex methodology; a quasideterministic methodology. The control refining module may utilize functional evaluations for refining the closed loop feedback control.

The quantum system controller may be included in any of the following: a mass spectrometer; a quantum dynamic discriminator for analyzing a composition; a sample identification system for ascertaining the identity of at least one component in a composition; a sample identification system for ascertaining an identifying characteristic of at least one component in a composition; a device for ascertaining the molecular structure of a quantum system; an optimal identification device for ascertaining the quantum Hamiltonian of the quantum system. The quantum system controller may perform guided control over a quantum system landscape.

One or more computer programs may be included in the implementation of the apparatuses and methodologies of this application. The computer programs may be stored in a machine-readable program storage device or medium and/or transmitted via a computer network or other transmission medium.

The techniques of the present disclosure can function as a component directing the operations of laser pulse shaping apparatus. Examples of such apparatuses are disclosed in commonly owned U.S. applications Ser. No. 10/322,693, filed Dec. 18, 2002, and Ser. No. 10/505,941, filed Aug. 25, 2004, the disclosures of which are incorporated herein in their entireties by reference. Additional examples are discussed in U.S. applications Ser. No. 10/265,211, filed Oct. 4, 2002, and Ser. No. 10/628,874, filed Jul. 28, 2003 (Dantus et al.).

The specific embodiments described herein are illustrative, and many variations can be introduced on these embodiments without departing from the spirit of the disclosure or from the scope of the appended claims. Elements and/or features of different illustrative embodiments may be combined with each other and/or substituted for each other within the scope of this disclosure and appended claims.

Non-limiting details of exemplary embodiments are described below, including discussions of theory and experimental simulations which are set forth to aid in an understanding of this disclosure but are not intended to, and should not be construed to, limit in any way the claims which follow thereafter.

Quantum optimally controlled transition landscapes As discussed further below, a large number of experimental studies and simulations were conducted showing that it is surprisingly easy to find excellent quality control over broad classes of quantum systems. Experimental simulations show that for controllable quantum systems with no constraints placed on the controls, the only allowed extrema of the transition probability landscape correspond to perfect control or no control. Under these conditions, no suboptimal local extrema exist as traps that impede the search for an optimal control. The identified landscape structure is universal for all controllable quantum systems of the same dimension when seeking to maximize the same transition probability, regardless of the detailed nature of the system Hamiltonian. The presence of weak control field noise or environmental decoherence is shown to preserve the general structure of the control landscape, but at lower resolution.

The control of quantum phenomena is garnering increasing interest for fundamental reasons as well as on account of its possible applications. In general, the redirecting of quantum dynamics is sought to meet a posed objective through the introduction of an external control field C(t), often expressed as a function of time and frequently being electromagnetic, arising from laser sources. The field of optimal control theory (OCT) arose for the design of controls in simulated systems, and the ultimate interest lies in executing optimal control experiments (OCEs). By employing closed-loop learning control techniques, the number of such experiments is rapidly rising. At this juncture, there are many OCT studies exploring the control of broad varieties of quantum phenomena, and OCEs have similarly addressed several types of physical situations, including the selective breaking of chemical bonds, the creation of particular molecular vibrational excitations, the enhancement of radiative high harmonics, the creation of ultrafast semiconductor optical switches, and the manipulation of electron transfer in biological photosynthetic antenna complexes. Applications to other areas can also be envisioned, including quantum information sciences. Typical OCT and OCE studies involve the manipulation of tens or even hundreds of control variables corresponding to the discretization of the control C(t) in either time or the analogous frequency domain representation. Almost all of the OCT design calculations use local search techniques seeking an optimal control C(t), whereas the current laboratory OCE applications have all used global genetic-type techniques. In the case of OCT, a very striking result is that all of the calculations are generally giving excellent-quality product yields. In the case of OCEs with laser controls, the absolute yields are not known, although a basic finding is the evident ease of discovering control settings that can often dramatically increase the desired final product.

The above observations suggest that it is relatively easy to obtain good, if not excellent, solutions for quantum optimal control problems while searching through high-dimensional control variable spaces. Viewed as a generic optimization problem, this behavior is surprising. In the case of OCT, it is especially enigmatic because local techniques virtually always seem to give excellent results. Many and possibly a denumerably infinite number of control solutions may exist throughout the control search space. Few of the solutions may be of high quality. Under these collective conditions, finding a poor quality local control solution may be the expected outcome of an optimal search for C(t). The reason for this behavior lies in some generic aspects of controlled quantum dynamics, rather than in the details of each particular problem, because the favorable findings are occurring for the control of all aspects of quantum dynamics phenomena.

In laboratory OCE implementations, many less-than-ideal circumstances may arise, including the system being at finite temperature, the presence of environmental decoherence, constraints on the controls, control field fluctuations, and observation noise. In contrast, most of the OCT design calculations have been carried out under ideal conditions where these problems do not exist. Because the problematic circumstances in the laboratory can in principle be improved on through better engineering and operating conditions, here the limiting case is primarily examined. Some of the issues associated with less-than-ideal laboratory conditions may be returned to below.

Although quantum control applications can span a variety of objectives, most of those currently being explored correspond to maximizing the probability P_{i→f}=|U_{if}|² for making a transition from an initial state |i> to a desired final state |f>. Here, U_{if}=<i|U|f> is a matrix element of the unitary time evolution operator U=U[C(t)] which is a functional of the control C(t). The operator U captures all of the controlled evolution over the time interval 0≦t≦T out to some finite target time T. The physical goal is to maximize P_{i→f} with respect to the control C(t). Little is known about the mappings C(t) U, which are generally highly complex. The analysis below is general insofar as it requires no knowledge of the particular system or its Hamiltonian, except specification of the general criteria that the system is controllable for some time T. Consideration may be restricted to systems with a finite number of quantum states N, because the criteria for controllability have been established for this condition. Full controllability implies that at least one control field C(t) exists such that the result P_{i→f}=1 corresponds to the following extremum for all time 0≦t≦T:

$$\frac{δ {P}_{i} {\to }_{f}}{δ C ( t )} = 0 \qquad ( 1 )$$

It is evident that the transition probability is bounded by 0≦P_{i→f}≦1 and the control landscape P_{i→f}[C(t)] is explored as a functional of C(t) by considering the nature of all of the extrema satisfying Eq. 1. The control C(t) is allowed to vary freely without being constrained such that all extrema of P_{i→f} satisfy Eq. 1. Full controllability assumed as a basis for the analysis below does not preclude the existence of undesirable suboptimal solutions satisfying Eq. 1 with P_{i→f}<1 at the extrema. It may be stressed that an optimality analysis is distinct from a controllability assessment, which seeks only to establish the existence of at least one control that can exactly attain the target and generally reveals nothing about the nature of optimality (that is, the extrema of the optimal control landscape). The distinction between controllability and optimality is also evident in their formulations: Controllability involves no notions of examining a landscape and its extrema, whereas optimality typically relies on seeking extrema regardless of the controllability of the system. At this juncture in the development of quantum control, essentially nothing is known about the nature of the control landscapes. The aim is to reveal the general structure of the landscapes encountered when searching for optimal quantum controls.

In order to explore the landscape extrema, it is convenient to use the identity <i|U|f>=<i|exp (iA)|f> where A^{t}=A is an arbitrary N×N Hermitian matrix. Thus, Eq. 1 may be rewritten as follows:

$$\frac{δ {{P}_{i}}_{\to f}}{δ C ( t )} = {\sum }_{p , q} \frac{\partial {\vert {U}_{if} \vert}^{2}}{\partial {A}_{pq}} \frac{δ {A}_{pq}}{δ C ( t )} = 0 \qquad ( 2 )$$

The mapping C(t)→A may be equally as complex as the original mapping C(t)→U for most applications, and the replacement of U by exp(iA) does not at first appear to facilitate the analysis. However, the assumed controllability of the system implies that each of the matrix elements A_{pq}[C(t)] of A be independently addressable while still preserving the Hermiticity of A. Thus, each element A_{pq}[C(t)] may have a unique functional dependence on C(t) These points in turn imply that the set of functions {δA_{pq}/δC(t)} for all p and q are linearly independent over 0≦t≦T and the only way that Eq. 2 may be satisfied is to hold the following for all p and q:

$$\begin{matrix}\frac{\partial {\vert {U}_{if} \vert}^{2}}{\partial {A}_{pq}} = \frac{\partial }{\partial {A}_{pq}} {\vert 〈 ⅈ \vert exp ( ⅈ A ) \vert f 〉 \vert}^{2} & ( 3 a ) \\ = {U}_{if}^{*} \frac{\partial {U}_{if}}{\partial {A}_{pq}} + {U}_{if} \frac{\partial {U}_{if}^{*}}{\partial {A}_{pq}} = 0 & ( 3 b )\end{matrix}$$

The relation in Eq. 2 is now replaced by the Hamiltonian-free generic form in Eq. 3, which side steppes the need to solve the Schrodinger equation; and the system optimality can be analyzed from the kinematics of an arbitrary Hermitian A. This transformation reduced what appeared to be a highly complex system-specific analysis of Eq. 1 to a generic analysis for any controllable quantum system.

A detailed examination of Eq. 3 (23) leads to the following conclusion where a is a real phase such that |U_{if}|=1:
U_{if}=exp(iα) (4)
The analysis started with the implicit assumption that |U_{if}|≠0, although the possibility |U_{if}|=0 can certainly arise for non-zero-control fields. Thus, all of the quantum control landscape extrema satisfying Eq. 1 take on the following value with the landscape elsewhere having trivial extrema P_{i→f}=0:
P_{i→f}=1 (5)
The conclusion in Eq. 5 is a particular case of a general treatment of the landscapes for optimally controlled quantum observations based on a different analysis technique. One component of this outcome was arrived at in a Lie-theoretic treatment, which identified these absolute upper and lower values of the landscape. The present analysis is especially focused on explicitly revealing the structure of the time evolution operator U under optimization and exploring the physical implications of this result when searching for effective quantum controls. The result in Eq. 5 was also confirmed by numerically solving the optimality equations (3) for a number of cases of dimension N up to 10, and in all cases only perfect solutions were found.

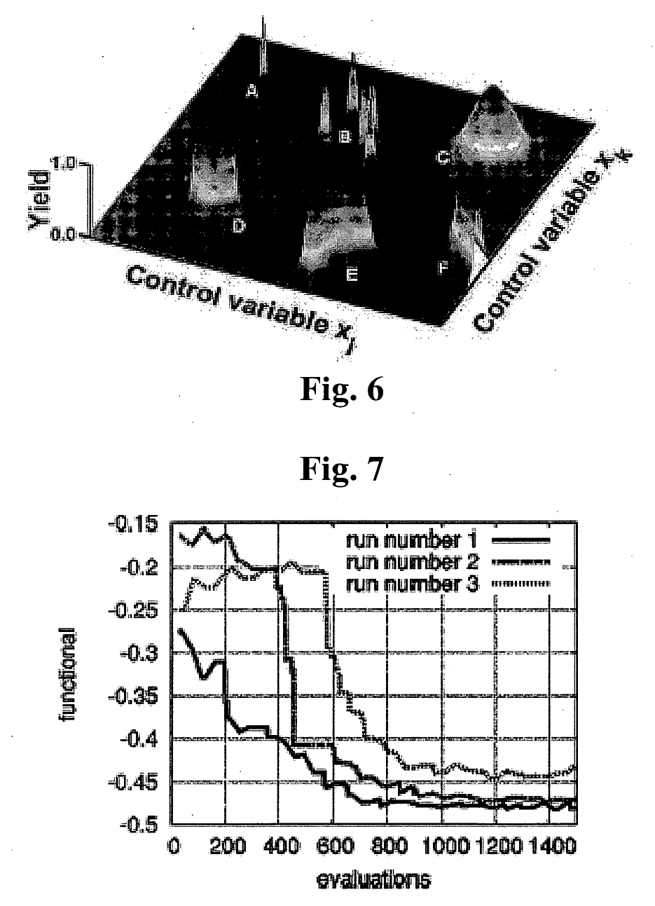

The surprising conclusion in Eq. 5 is that under the simple assumption of controllability, the only extrema values for quantum optimal control of population transfer correspond to perfect control. Recall that optimality and controllability are distinct concepts; with the latter generally not precluding extrema with values of P_{i→f}<1. Thus, quantum control of P_{i→f} exhibits the unusual highly attractive behavior that there are no less-than perfect, suboptimal local extrema to get trapped in when searching for an optimal control. This result immediately explains the general finding across virtually all of the hundreds of literature OCT studies that easily identified excellent control solutions. The analysis here does not reveal the multiplicity of solutions, but many distinct controls corresponding to individual extrema in Eqs. 2 or 3 are likely to exist in any application. Practical control landscapes are in very high dimensions, because the control C(t) is typically represented in terms of many variables for adjustment. Nevertheless, the essence of the landscape may be captured by the sketch in FIG. 6, just considering two of these variables denoted as xⱼ and Xₖ. Any optimal control study always starts with an initial trial control, and the figure indicates that regardless of that trial choice, the nearest optimal solution may always be perfect. Each trial solution starts out on an upward slope toward a control C(t) giving perfection, P_{i→f}=1. However, the character of the search for such solutions can depend on the technique used, and the nature of the solutions can be quite distinct. A very sharp extremum, as at point A, may not be robust to small control field variations and likely difficult to discover with techniques inevitably taking finite steps. Similarly, searching in the vicinity of a group of such narrow nonrobust solutions, as around domain B, may easily lead the search into exhibiting fibrillation behavior as it jumps from one local environment to another, taking on rather arbitrary P_{i→f} values without achieving convergence. Solutions of the type around point C may be easy to find because of their broad and rapidly attracting character. However, solutions of the type around point D are more robust to control variations and are the most attractive for discovery. Other extrema might exhibit partial robustness to one or combinations of the control variables as indicated by a solution of type E or F. Finally, the optimum near F at the edge of the depicted domain serves to point out that the control space is of arbitrary extent, and solutions may exist anywhere. These arguments fortunately also imply that finding robust control solutions is easier than finding nonrobust ones. The qualitative behavior depicted in FIG. 6 and the analysis leading to Eq. 5 explains the seemingly puzzling observation of increasingly successful OCT and OCE results while searching through high dimensional spaces of control variables. Naturally, a variety of issues in the laboratory, including the lack of total controllability, the presence of field fluctuations, noise in the observations, the initial state being statistically distributed, the presence of decoherence, and constraints on the controls may all cloud the strict conclusion in Eq. 5, which is valid under ideal conditions. It is beyond the scope of this report to delve into the intricate issues involved with these points, but some comments are warranted to place the present work in the context of the evolving OCE studies. First, less-than-ideal conditions may result in lowering the optimal yield to P_{i→f}<1 and begin to introduce roughness (that is, local suboptimal extrema) in the control landscape. A contributing factor to attaining less than perfect control is the fact that in all cases, the control is inevitably constrained in possibly many ways, including operating with a finite number of control variables of restricted range. The net result of constraints being placed on the controls can be a complex matter to assess, but numerical simulations show that field restrictions play an increasing role when approaching high yields (those greater than ˜0.8). The landscape of P_{i→f} revealed in the analysis above is independent of control restrictions, but access to certain regions of the landscape may be limited and the view of the landscape possibly distorted by field constraints. The latter behavior with constrained controls is likely the reason that typical OCT studies appear trapped in suboptimal, although generally still excellent, solutions. Finally, the use of various dynamical approximations (especially of a nonunitary nature) with significant errors may alter the landscape structure from that found here on general grounds.

The influences of field noise and environmental disturbances are generally complex matters to assess. A common and often reachable desire is to operate in the regime where these effects are weak; and in this case, a simple perturbation analysis may be carried out, providing a clear qualitative assessment of these effects on the control landscape. In the case of control noise, there may be an ensemble of similar controls {C₁(t)}, l=1, 2, . . . and the laboratory observable may be an average pⁿ_{i→f}=<P_{i→f}> over the ensemble {C₁}. Here, P_{i→f} is the original landscape with sharply defined perfect features (as characterized in FIG. 6). If the noise is weak, then its influence may be to act as a filter providing a lower resolution view Pⁿ_{i→f} of the original landscape P_{i→f} This filtered view most strongly affects the nonrobust solutions, such as at A and B in FIG. 6, by significantly reducing their value. In contrast, the desirable robust landscape features (solutions) at C and D may be little affected.

Weak decoherence shows a similar influence. In this case, the “system” still may have N states, including |i> and |f>, but there is additionally a set of “bath” states {|b>}. The standard view of decoherence is to average over the initial probability density ρ_{b} of bath states, where Σ_{b}μ_{b}=1 and sum over all final bath states to give the observation of interest as P^{dec}_{i→f}=Σ_{b,b′} ρ_{b} P_{ib→fb′}. For a fixed desired system transition |i>→|f>, there is a landscape P_{ib→fb′} like that in FIG. 6 for each pair |b> and |b′> of bath states. With an environmental bath weakly coupled to the system, it is natural to assume that the family of landscapes P_{ib→fb′} are all similar, and the summation above again gives a lower resolution view p^{dec}_{i→f}=of the nominal sharp decoherence-free landscape. The net outcome is then the same as with weak field noise.

Cases of strong field noise and decoherence may easily and greatly distort the landscape, but these are conditions to be avoided if possible, because much of the power of quantum control may be lost in this regime. Thus, the results in Eq. 5 provide the basis to expect that high-quality quantum control may be easily attainable under reasonable circumstances. The work shows that as laboratory conditions approach the ideal limit, the landscape is devoid of false traps in seeking to make a transition |i>→|f>. The establishment of the main results in this paper arose from separating the very complicated functional dependence of P_{i→f} [C(t)] upon C(t) into a two-step analysis of (i) A_{pq}[C(t)] and (ii) ∂<i|exp (iA)|f>/∂A_{pq}. Step (i) still involved an equally complex functional mapping of the control field in A[C(t)]; this difficult aspect of quantum control to unravel, which is application-specific, was put aside by just drawing on the uniqueness of each functional mapping A_{pq}[C(t)] for all p and q. In this fashion, the analysis reduced to examining step (ii) through the kinematical structure in Eq. 3, which was thoroughly decomposed.

FIG. 6 is a chart illustrating the general behavior of the quantum optimal control landscape for the probability P_{i→f} of making a transition (that is, the yield) from quantum state |i> to |f>. The probability P_{i→f} is a functional of the control field C(t), and in practice C(t) is often expressed in terms of a large number of control variables x₁, l=1, 2, 3, . . . . The landscape is depicted here as a function of two arbitrary control variables xⱼ and xₖ. All the control extrema correspond to perfect yields P_{i→f}=1 as demonstrated under ideal physical conditions. Under these conditions, no suboptimal local extrema exist as traps when seeking optimal quantum controls. Various classes of extrema A to E exist, with differing ease of discovery and robustness properties. The extremum at F points out that other solutions of similar character can exist elsewhere throughout the control space.

These findings sharply contradict the intuitive expectation that the typically high dimensional quantum control search spaces may generally contain suboptimal solutions. A further surprising result is the generic nature of the landscape topology deduced by the kinematic analysis. When seeking to maximize the transition |i>→|f> for a controllable system of dimension N, the landscape structure is invariant to the choice of |i> and |f> as well as any details of the Hamiltonian. Differences in search behavior over the landscape can in practice arise due to the particular nature of the Hamiltonian and the control. Nevertheless, the optimal control landscape topology identified in this work is universal.

The solution to Eq. 3 is discussed below, thereby leading to Eq. 4. The analysis of Eq. 3a is facilitated by the diagonalization of A with a unitary transformation Q, such that Q^{t}AQ=λ, with λ being a diagonal matrix of the eigenvalues of A. The expression in Eq. 3b can be put into a practical form by using the following identity:

$$\frac{\partial {U}_{if}}{\partial {A}_{pq}} = ⅈ {\int }_{0}^{1} 〈 ⅈ \vert exp ( ⅈ A ( 1 - s ) ) \frac{\partial A}{\partial {A}_{pq}} exp ( ⅈ A s ) \vert f 〉 ⅆ s .$$

Applying standard operations from linear algebra leads to the following:

$$\frac{\partial {U}_{if}}{\partial {A}_{pq}} = ⅈ {\int }_{0}^{1} {\sum }_{l , {l}^{′}} {\sum }_{r , s} 〈 ⅈ \vert Q \vert l 〉 exp ( ⅈ {λ}_{l} ( 1 - s ) ) 〈 l \vert {Q}^{†} \vert r 〉 〈 r \vert \frac{\partial A}{\partial {A}_{pq}} \vert s 〉 〈 s \vert Q \vert {l}^{′} 〉 exp ( ⅈ {λ}_{{l}^{′}} s ) 〈 {l}^{′} \vert {Q}^{†} \vert f 〉 ⅆ s \qquad ( S .1 )$$

Using the relation

$$\frac{\partial {A}_{rs}}{\partial {A}_{pq}} = {δ}_{rp} {δ}_{sq} ,$$

simplifies Eq. S.1 to the following:

$$\frac{\partial {U}_{if}}{\partial {A}_{pq}} = {\sum }_{l , {l}^{′}} [ 〈 ⅈ \vert Q \vert l 〉 〈 l \vert {Q}^{†} \vert p 〉 〈 q \vert Q \vert {l}^{′} 〉 〈 {l}^{′} \vert {Q}^{†} \vert f 〉 ] ( \frac{exp ( ⅈ {λ}_{{l}^{′}} ) - exp ( ⅈ {λ}_{l} ) }{ {λ}_{{l}^{′}} - {λ}_{l}} ) . \qquad ( S .2 )$$

A similar expression can be written for

$$\frac{\partial {U}_{if}^{*}}{\partial {A}_{pq}}$$

in Eq. 3b where the difference is the replacement λ→−λ in Eq. S.2. Without any loss of generality, the analysis of Eq. 3b is aided by making the following unitary transformation for all r and s, which eliminates the sums over l and l′ in Eq. S.2 utilizing the unitarity of Q.

$${\sum }_{p , q} 〈 r \vert {Q}^{†} \vert q 〉 \frac{\partial {\vert {U}_{if} \vert}^{2}}{\partial {A}_{pq}} 〈 p \vert Q \vert s 〉 = 0 \qquad ( S .3 )$$

Combining Eqs. 3b, S.2 and S.3 yields the following working relationship:

$$\begin{matrix}{U}_{if}^{*} 〈 ⅈ \vert Q \vert s 〉 〈 r \vert {Q}^{†} \vert f 〉 F ( {λ}_{r} , {λ}_{s} ) + {U}_{if} 〈 f \vert Q \vert s 〉 〈 r \vert {Q}^{†} \vert ⅈ 〉 {F}^{*} ( {λ}_{r} , {λ}_{s} ) = 0 & ( S .4 ) \\ where F ( {λ}_{r} , {λ}_{s} ) = \{ \begin{matrix}ⅈ exp ( ⅈ {λ}_{r} ) & if & {λ}_{r} = {λ}_{s} \\ \frac{exp ( ⅈ {λ}_{r} ) - exp ( ⅈ {λ}_{s} ) }{ {λ}_{r} - {λ}_{s}} & if & {λ}_{r} \neq {λ}_{s}\end{matrix} & ( S .5 )\end{matrix}$$

The following phase and amplitude decomposition of the relevant variables <l|Q|l′>=|<l|Q|l′>| exp(iΦ^{l}ₗ) and U_{if}=|U_{if}| exp (iα) , where Φ^{l}ₗ and α are real phases are introduced. By first considering 1 Eq. S.5 for r=s such that λᵣ=λₛ, Eq. S.4 can be rewritten as follows:

$$\frac{{U}_{if}}{{U}_{if}^{*}} = exp ( 2 ⅈ ( {ϕ}_{r}^{i} - {ϕ}_{r}^{f} + {λ}_{r} ) ) . \qquad ( S .6 )$$

Since U_{if}/U*_{if}=exp(2iα), the following phase relationship, where nᵣ is an integer may be obtained:
φᵣⁱ−φᵣ^{f}+λᵣ−α=πᵣπᵣ (S.7)

Examining the other case arising in Eq. S.5 for arbitrary r and s values, Eq. S.4 can be rewritten as follows:

$$\frac{〈 i \vert Q \vert s 〉}{〈 f \vert Q \vert s 〉} = - \frac{{U}_{i f} 〈 r \vert {Q}^{†} \vert i 〉 {F}^{*} ( {λ}_{r} , {λ}_{s} )}{{U}_{i f}^{*} 〈 r \vert {Q}^{†} \vert f 〉 F ( {λ}_{r} , {λ}_{s} )} . \qquad ( S .8 )$$

Taking the norm of both sides of Eq. S.8 and assuming that the transformation matrix elements are nonzero, the following can be seen:

$$\vert \frac{〈 i \vert Q \vert s 〉}{〈 f \vert Q \vert s 〉} \vert = \vert \frac{〈 r \vert {Q}^{†} \vert i 〉}{〈 r \vert {Q}^{†} \vert f 〉} \vert = δ , \qquad ( S .9 )$$

where δ is a constant that is independent of the indices r and s, since Eq. S.9 is to be valid for all r and s values. Squaring Eq. S.9 and utilizing the normality of the row vectors of Q, it follows that δ²Σₛ|<f|Q|s>|²=Σₛ|<i|Q|s>|²=1, implying that δ=1. Thus, the optimality criteria in Eq. S.4 forces a relationship to exist in Eq. S.9 between the matrix elements of Q that diagonalize A.

In terms of the phase and amplitude decomposition defined above, the optimization condition in Eq. S.4 can be expressed as follows:

$${U}_{i f}^{*} \vert 〈 i \vert Q \vert s 〉 \vert \vert 〈 r \vert {Q}^{†} \vert f 〉 \vert exp ( ⅈ ( {ϕ}_{s}^{i} - {ϕ}_{r}^{i} ) ) F ( {λ}_{r} , {λ}_{s} ) + {U}_{i f} \vert 〈 f \vert Q \vert s 〉 \vert \vert 〈 r \vert {Q}^{†} \vert i 〉 \vert exp ( ⅈ ( {ϕ}_{s}^{f} - {ϕ}_{r}^{i} ) ) {F}^{*} ( {λ}_{r} , {λ}_{s} ) = 0 \qquad ( S .10 )$$

This expression may be rewritten as follows where Eq. S.9 was used along with δ=1:

$$\begin{matrix}exp [ ⅈ ( {ϕ}_{r}^{i} + {ϕ}_{s}^{i} - {ϕ}_{r}^{f} - {ϕ}_{s}^{f} ) ] = - \frac{{U}_{if} {F}^{*} ( {λ}_{r} , {λ}_{s} ) \vert 〈 f \vert Q \vert s 〉 \vert \vert 〈 r \vert {Q}^{†} \vert i 〉 \vert}{{U}_{if}^{*} F ( {λ}_{r} , {λ}_{s} ) \vert 〈 i \vert Q \vert s 〉 \vert \vert 〈 r \vert {Q}^{†} \vert f 〉 \vert} \\ = - \frac{{U}_{if} {F}^{*} ( {λ}_{r} , {λ}_{s} )}{{U}_{if}^{*} F ( {λ}_{r} , {λ}_{s} )} \\ = - exp ( 2 ⅈ α ) \frac{{F}^{*} ( {λ}_{r} , {λ}_{s} )}{F ( {λ}_{r} , {λ}_{s} )} \\ = exp ( 2 ⅈ α ) exp ( - ⅈ ( {λ}_{r} + {λ}_{s} ) )\end{matrix} \qquad ( S .11 )$$

By virtue of the phase relationship in Eq. S.7, the LHS of Eq. S.11 can be rewritten as exp(2iα−i(λᵣ+λₛ)+(nᵣ+nₛ)π). From this, it follows that since nᵣ and nₛ are mutually independent, then nᵣ and nₛ may either be both even or both odd.

Armed with the results above, the value of the desired matrix element may be considered as follows:

$$\begin{matrix}{U}_{if} = 〈 i \vert exp ( ⅈ A ) \vert f 〉 \\ = {\sum }_{r} 〈 i \vert Q \vert r 〉 exp ( ⅈ {λ}_{r} ) 〈 r \vert {Q}^{†} \vert f 〉 \\ = {\sum }_{r} exp ( ⅈ ( {λ}_{r} + {ϕ}_{r}^{i} - {ϕ}_{r}^{f} ) ) {\vert 〈 ⅈ \vert Q \vert r 〉 \vert}^{2} .\end{matrix} \qquad ( S .12 )$$

Utilizing Eq. S.7 and assuming without loss of generality that all nᵣ are even, the foregoing can be expressed as follows which is Eq. 4:

$$\begin{matrix}{U}_{if} = exp ( ⅈ α ) {\sum }_{r} {\vert 〈 ⅈ \vert Q \vert r 〉 \vert}^{2} \\ = {exp ( ⅈ α )}_{1} \end{matrix} \qquad ( S .13 )$$

If the nᵣ are odd, U_{if} may only acquire a phase of −1, which may not affect the ultimate conclusion of the analysis.

The proof leading to Eq. S.13 just rests on the generic structure of quantum control, which is consistent with the broad-scale success of present OCT and OCE studies in very diverse quantum systems. The essence of the dynamical evolution producing perfect control in Eq. S.13 and Eq. 5 may be viewed from another perspective. In examining Eq. S.12, note that if the term exp(iλᵣ) is removed from the sum, then there may simply be orthogonality between <i|Q|r> and <i|Q|r>* as Q is unitary. However, the optimization process seeks out a control producing the coordinated relations in Eq. S.7 and Eq. S.9, respectively, between the phases of the matrix elements <i|Q|r> and <i|Q|r>* as well as between their magnitudes. In this way, these vectors rotate to coincide with each other, thereby producing perfect control.

Techniques for Laboratory Discovery of Optimal Uqantum Controls

Laboratory closed-loop optimal control of quantum phenomena, expressed as minimizing a suitable cost functional, is often implemented through an optimization technique coupled to the experimental apparatus. In practice, most conventional search techniques are variants of genetic techniques. As an alternative choice, a direct search deterministic methodology is discussed herein. For the simple simulations studied as discussed herein, it outperforms the existing approaches. An additional technique, as discussed below in this section, was used in order to reveal some properties of the cost functional landscape.

Laser manipulation of quantum dynamics involves the tailoring of a control field, often from a laser, to optimally steer the system toward a desired target outcome. The underlying phenomenon utilized to achieve such goals is the manipulation of quantum interferences in the evolving dynamics driven by the laser field. The success of any particular laser field is measured in terms of a cost functional that incorporates the achieved metric distance to the target, and possibly other auxiliary costs such as the laser pulse energy. The subject of quantum control may have well-defined theoretical foundations and an extensive literature. In addition to the theoretical developments, numerous optimal control experiments have demonstrated the feasibility of the approach. In particular, the most dramatic experimental advances, especially over control of complex systems, have utilized the so-called closed-loop paradigm, introduced a decade ago. The laser field is updated from one experiment to the next, on the basis of a measure of the distance to the desired target goal. The quantum system subjected to control is used in the laboratory, within the optimization loop, as an analog computer to integrate its own evolution equation. The control terminology of “closed-loop”, as opposed to “open-loop”, means that the distance to the target is evaluated on-the-fly and serves as a guideline to modify the control, in order to further optimize the result upon traversing the loop once again, etc. The loop is closed from one experiment to the next with a new sample of the quantum system, as it is both difficult to react in the extremely small time window between experiments, and almost impossible, in the quantum framework, to observe the state of a system without modifying the system itself in some unknown way.

When carrying out the closed-loop optimal control paradigm, a natural consideration is which type of optimization technique is preferable to guide the evolving experiments. Following the original work, practitioners of the field have used stochastic-like techniques, and more precisely genetic algorithms (GA), that have proved to be surprisingly efficient in this context. To justify the use of GAs, it is often argued that other types of techniques, mainly deterministic techniques, present major drawbacks that prevent them from being efficient in this context involving the optimization of a nonconvex cost function in a high-dimensional search space with a significant degree of laboratory noise. In some circumstances, appropriate deterministic techniques (possibly with a small amount of introduced randomness) can perform equally well and even outperform GAs by an order of magnitude in terms of the number of functional evaluations (i.e., experiments) required. A discrete descent methodology which gives us some insight into the shape of the cost functional surface is also introduced to provide a possible explanation of why the GAs perform well in this laser control problem and why they can be outperformed by such deterministic techniques. Before presenting the techniques and evaluating their efficiency, it is useful to draw up a list of the main features of the optimization problem at hand, and to see how these features impact on the qualities needed for a technique to perform well.

As the optimization technique operates with the laboratory experiments, access may be limited to measurements on the system such that the cost functional can be evaluated for each trial laser field. No derivatives with respect to the laser field are directly available, in contrast to the situation arising when the control process is simulated numerically. So far, this optimization context is the same as in any practical problem in the control engineering sciences. However, quantum control distinguishes itself in one way: the cost function evaluation is unprecedented in its cheapness. Present experiments may be performed at the rate of hundreds or more per second and available technology may in principle operate at a million per second. The need for signal averaging may reduce these numbers, but they still remain far from the standard duty cycle of engineering applications. The quantum control situation suggests that the optimization technique may be of order zero (i.e., only function evaluations are involved with no derivatives) or gradient-free to exploit the ability to perform massive numbers of experiments. Such a criterion immediately suggests using Monte Carlo-type methods, including GAs, but this is not the only choice, as shown below.

A second key issue is robustness with respect to noise in the observations, and especially in the controls. This matter is of particular concern for the control of quantum systems, where the manipulation of quantum interference may be sensitive to noise. It is therefore of primary interest to have an optimization technique that is as robust as possible with respect to noise. A related matter is the presence of slow drift (i.e., slower than the closed-loop cycle time) in the laser or other apparatus components over the time of the experiment. Such drift is often not critical when considering control alone as the goal, but other auxiliary goals can be affected by drift. Thus, significantly reducing the number of experiments with faster techniques is of prime interest. This point may also be applicable for control cases where the target is, by some suitable measure, very far from the initial state, thereby calling for extensive searching to find an effective control.

A third feature of the quantum control problem is the expected general nonconvexity of the cost functional. Although this feature is not peculiar in comparison with other problems in the engineering sciences, it can be particularly vexing in quantum control. A consequence is the risk that the search technique gets trapped in a local poor-quality extremum. It is therefore crucial to ensure that the technique have good global search properties (i.e., the ability to search for an extremum by efficiently scanning over a large range of control parameter values) as opposed to a local search, which optimizes in the vicinity of the current iteration. Again, this may seem to suggest approaches using random variations in one way or another in executing the search, but this choice is not the only class of techniques as argued in this work.

A final main feature of quantum control experiments is the accessible high dimensionality of the search space with hundreds of phases and amplitude parameters (knobs) that define the laser field. Typically, each of these variables is discretized to about 50 values over its domain of variation. Thus, an enormous space is available for exploration in the experiments. Such a circumstance is within the standard range encountered in other nonlinear nonconvex optimization.

Given the criteria above, a control technique with the following properties may be sought:
(a) Utilizes only function evaluations;
(b) Exploits the high duty cycle of the experiments;
(c) Assures robustness with respect to noise as best as possible;
(d) Avoids being trapped in an uninteresting local extremum; and
(e) Works effectively in high-dimensional searches.

Some good candidates to fulfill the above list are discussed below. All of these candidates are well-established strategies that have proved their efficiency in other contexts. Comparisons between one of these techniques and the GA on a simple model quantum control problem that is physically relevant and that embodies all the main difficulties of the generic problem are discussed below. The conclusion is that GAs are not the only way to proceed and other techniques may be significantly more efficient. A new quasideterministic technique that is used to obtain some insight into the cost function landscapes is also discussed below. This result suggests one possible explanation of the success of GAs in this context, and also permitted us to further tune the techniques for even better efficiency.

Before presenting the particular techniques tested, some techniques that only use point value information and not the gradients (i.e., so-called “direct search” or “gradient-free” optimization) may be briefly surveyed. Different trends can be identified.

(1) Genetic or evolutionary algorithms. These form an example of stochastic techniques that have proved to be useful in a wide variety of engineering contexts. Additional details on the tested technique are discussed below.

(2) Hierarchical methodologies. These pattern search techniques organize the search on hierarchical lattices in the parameter space. The solution iteratively wanders from one point of the lattice system to another according to rules that take into account cost function information in the form of a finite difference scheme. Convergence theory for these techniques is well established and the presence of constraints may be accounted for, but the case of noisy cost functions is not completely analyzed yet. A related approach treats noise and establishes convergence properties. An assumption used in the proof is that the noise amplitude is weaker around the extrema, which is an open question for quantum control cost functionals.

(3) Simplex methodologies. The so-called simplex search procedure is based on using a set of N+1 points forming a nondegenerate geometrical object in the N-dimensional space (e.g., triangle in 2D, tetrahedron in 3D, etc.). A common form of this procedure is the Nelder-Mead algorithm and its modifications to treat noisy functions. A short description of the Nelder-Mead simplex methodology is as follows: the simplex can be viewed as “rolling” on the cost function surface. Depending on the outcome of the current “roll” step, the simplex is either expanded when it successfully improves the cost function (i.e., minimum) value or contracted (presumably to get through a narrow valley) when it cannot improve the minimal value. Further details are discussed below.

(4) Ordinal optimization. The “ordinal optimization” framework accommodates high noise amplitudes. It relies on an ordering approach that aims to find designs that belong to a particular percentile of all designs (but whose cost functional values are hopefully not significantly inferior to the true optimum).

Starting from the list above, the performance of two techniques for noisy cost functionals arising in quantum control: (A) a modified simplex methodology, and (B) an evolutionary strategy (GA) algorithm, may be tested.

Below, the goal is minimization of the cost functional, J(x₁, . . . , xₙ): R^{N}→R, which characterizes the control problem and where x₁, . . . , xₙ are the control “knobs” that can be adjusted in practical laboratory experiments.

The following discussion presents a modified simplex methodology. The algorithmic rules are given below.
(1) Initialization. In this step N+1 points X¹, . . . , x^{N+1} are randomly chosen to form the vertices of a nondegenerate simplex in the N-dimensional search space (i.e., the geometrical simplex figure having strictly positive volume; for example, in 2D the three points cannot be collinear, in 3D the four points cannot be on the same plane, etc.). For each point x^{k} the cost functional J(x^{k}) is evaluated, k=1, . . . , N+1.
(2) Reflection. The simplex vertices are ordered by the computed value of the cost functional. The highest J^{high}, second highest J^{sechi}, and lowest J^{low} values are identified and the corresponding points are denoted as x^{high} x^{sechi}, and x^{low}, respectively. The centroid x^{cent} of all the vertices except x^{high} is computed, and a new vertex x^{refl} is generated by reflecting x^{high} through x^{cent} by the following formula:
   x^{refl}=(1+α)x^{cent}−αx^{high}. (1)

The value used here is a=l Depending on the value of J^{refl}, the technique branches to one of the following alternatives:
(a) Accepted reflection. If J^{low}≦j^{refl}≦j^{sechi}, then x^{refl} replaces x^{high} in the simplex; the current iteration finishes and the control is passed to step 3.
(b) Attempt expansion. If J^{refl}<J^{low}, then the reflection is expanded to further exploit the current “search direction.” The expanded point is given by the following formula:
   x^{exp}=yx^{refl}+(1−y)x^{cent}. (2)

The expansion coefficient γ may be taken as 2 in the present work. The value J^{exp} of the cost functional at x^{exp} is computed and the iteration utilizes one of the following alternatives:
(i) Accept expansion. If J^{exp}<J^{low}, then x^{exp} replaced x^{high} in the simplex.
(ii) Reject expansion. If J^{exp}≧J^{low}, then the expansion is rejected and x^{refl} replaces x^{high}.

The current iteration finishes and the control is passed to step 3.
(c) Attempt contraction. If the newly constructed vertex x^{refl} does not improve the cost functional in the new simplex, i.e., if J^{refl}>J^{sechi}, then the simplex contracts. The contraction begins by first selecting the lowest cost functional associated with x^{high} and x^{refl} (i.e., if J^{refl}≦J^{high}, then x^{refl} replaces x^{high} and J^{refl} replaces J^{high}). The contraction vertex is as follows:
   x^{cont}=βx^{high}+(1−β)x^{cent}. (3)

The contraction coefficient is chosen as β=0.5 in this work. The value J^{cont} corresponding to x^{cont} is computed and the following alternatives arise:
(i) Accept contraction. If j^{cont}≦J^{hight}, then the contraction is accepted; the current iteration finishes and the control is passed to step 3.
(ii) Shrink. If J^{cont}>J^{hight}, then the whole simplex shrinks around x^{low} such that each point except x^{low} is modified by the following formula:
   x^{k}=δx^{k}+(1−δ)x^{low}. (4)

Here the shrinkage factor δ=0.9 is used. The methodology then evaluates J at each point (including x^{low}); the current iteration finishes and the control is passed to step 3.
(3) Stopping criterion. Iterations continue until the stopping criterion is met; in the present work the stopping criterion is based on the volume of the simplex, which is not allowed to drop below a certain dimension-normalized value. This logic is based on a shrinking simplex, implying that the search is converging in a local minimum of the cost functional.

Another useful criterion is to set a bound on the total number of iteration steps. If the stopping criterion is not met, then the methodology begins a new iteration at step 2.

The second technique used is an evolutionary strategy optimization algorithm. The evolutionary strategies are one of the most efficient descendants of the genetic algorithms. The implementation used here is the EO Evolutionary Computation Framework. Some of the settings are given below.
(i) Nonisotropic mutation.
(ii) Population size was taken to be 10, with the percentage number of offspring being 1000%.
(iii) Initialization bounds for the pulse amplitudes are [−0.10, 0.10] and for the phases [−n, n]; during a run the final amplitudes were bounded over [−0.5, 0.5] and no restrictions were imposed on the phases [see Eq. (5) below in this section].

Note that with these parameters each generation may require 100 cost functional evaluations (i.e., experiments), except for the initial step that may require 10 evaluations. As a stopping criterion a maximum number of 300 generations was imposed.

With a slight abuse of language in order to generally conform to the control literature, this procedure may be denoted as a “GA,” although it is actually an evolutionary strategy.

The techniques discussed above were successfully tested on typical optimization benchmarks extracted from the literature, in addition to noise-free quantum control problems. In order to better model the experimental conditions, quantum control simulations where both control field and measurement noise are present were conducted.

The modified simplex methodology and the evolutionary learning strategy were applied to a model 10-level quantum system presented earlier. The numerical values below have the units of fs for time, rad/fs for frequency and energy, and V/Å for the electric field. The field is expressed as follows in terms of fixed frequencies ω₁, with the amplitudes α₁ and phases θ₁ being the control variables for optimization:

$${ε}_{c} ( t ) = {ε}_{0} exp [ - {( ( t - T / 2 ) / σ )}^{2} ] {\sum }_{l = 1}^{L} {a}_{l} cos ( {ω}_{l} t + {θ}_{l} ) . \qquad ( 5 )$$

A total of 32 variables (i.e., L=16) was optimized corresponding to selected single, double, and triple quantum transitions.

The physical objective in the cost functional as follows is to maximally project onto a target state |ψ_{T}> at time T balanced with a laser fluence penalty weighted through a parameter μ≧0:

$$\begin{matrix}J ( {a}_{1} , … , {a}_{L} , {θ}_{1} , … , {θ}_{L} ) = J ( ε ( t ) ) & ( 6 ) \\ = \frac{μ}{2} {\int }_{O}^{T} {ε}^{2} ( t ) ⅆ t - \frac{1}{2} \vert 〈 Ψ \vert {Ψ}_{T} 〉 {\vert}^{2} . & \end{matrix}$$

Initially, the system is in its ground state and the target |ψ_{T}> is chosen to be the fifth excited state. The system was simulated over a total time T=500; Eq. (5) of this section sets σ=200 and e₀=1. The system may be fully controllable and when μ=0 the minimum possible value for J is −0.5, which corresponds to 100% overlap with the target state |ψ_{T}>; as μ>0 increases, this global optimum value also increases. The techniques may be compared for several values of μ. In all cases a noisy cost functional J^{˜} is optimized which is computed from J by building noise into the field ε (t) through the amplitudes a₁, . . . , a₁₆ and the phases θ₁, . . . , θ₁₆. In order to simulate field noise these values are perturbed by aₖ→aₖ (1+0.02·η^{a}ₖ), where η^{a}ₖ are independent, uniform, random variables taking values in [−1; 1] (this may be called 2% relative amplitude noise); similarly, the phases are randomly altered by θₖ→θₖ·(1 0.1·η^{θ}ₖ) (1% relative phase noise). This produces a noise-contaminated modified field εₘ(t) The terms

$$μ / 2 {\int }_{O}^{T} {∈}_{m}^{2} ( t ) ⅆ t$$

and ½|<ψ|ψ_{T}>|² of the cost functional for this modified field are then computed. The observation of the field fluence and the target were both taken to have a noise level of 0.05 (5% relative noise). Unless (1+0.05)|<ψ|ψ_{T}>|²>1 (see below), the two terms in the cost functional were multiplied by (1+0.05·η₁) and (1+0.05·η₂), respectively, where η₁, η₂ are uniform random variables with values in [−1;1], such that

$$\tilde{J} ( {a}_{1} , … , {a}_{16} , {θ}_{1} , … , {θ}_{16} ) = ( 1 + 0.05 \cdot {η}_{1} ) \frac{μ}{2} {\int }_{0}^{T} {∈}_{m}^{2} ( t ) ⅆ t + \\ ( 1 + 0.05 \cdot {η}_{2} ) \frac{1}{2} {\vert 〈 Ψ \vert {Ψ}_{T} 〉 \vert}^{2} .$$

The value of J^{˜} is returned to the evaluation routine except when (1+0.05)|<ψ|ψ_{T}>|²>1, whereupon the relative noise for the target is modified to 1/|<ψ|ψ_{T}>|²−1 in order to avoid unphysical noisy values above the maximum target overlap of 1.0. In this case the returned cost functional value is as follows:

$$\tilde{J} ( {a}_{1} , … , {a}_{16} , {θ}_{1} , … , {θ}_{16} ) = ( 1 + 0.05 \cdot {η}_{1} ) \frac{μ}{2} {\int }_{0}^{T} {∈}_{m}^{2} ( t ) ⅆ t + \\ ( 1 + ( \frac{1}{{\vert 〈 Ψ \vert {Ψ}_{T} 〉 \vert}^{2}} - 1 ) {η}_{2} )$$

$$\frac{1}{2} {\vert 〈 Ψ \vert {Ψ}_{T} 〉 \vert}^{2} .$$

For both tested techniques three runs are taken starting at random initial guesses; typical sample runs are shown in FIGS. 7-9. In the laboratory an ensemble of experiments may be performed with the actual cost being the average over the ensemble.

FIG. 7 is a chart illustrating results for μ=0.0 (simplex methodology); the abscissa is the number of cost functional evaluations, and the ordinate is the noisy cost functional values for these typical runs. The relative noise levels are 1% for phases, 2% for amplitudes, and 5% observation noise. Good quality results are obtained with the cost functional converging close to the optimum value of −0.5. Similar results are obtained for other small weights such as μ=0.001.

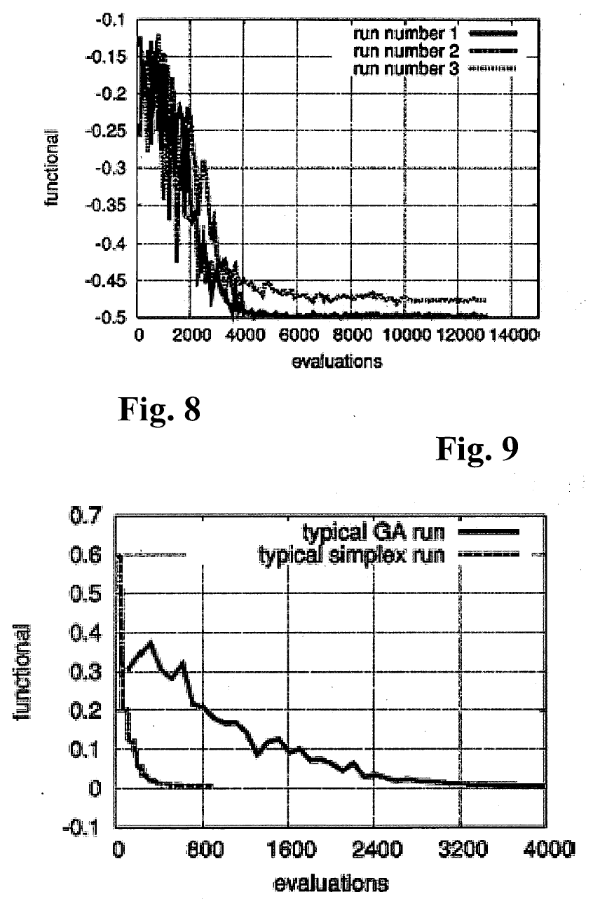

The parameter μ may be chosen carefully in order for the minimization of the cost functional to give a good target value. If μ is too large, such as μ=0.1 in FIG. 9, the solution may converge toward the zero field, as too much weight is put on the fluence term ∫^{T}₀ ε(t)² dt. In the range μ≦0.001 that gives satisfactory solutions for the control problem, both techniques find many local minima that have overlaps with target typically in the range of 60%-90% (if μ is lowered this quality increases). In these cases both techniques are sometimes trapped in a local minimum of lesser quality, but running several times eventually ensures finding acceptable quality results. When μ is lowered to μ=0.0001 (and even more so for μ=0) , then good quality solutions are almost always found. The results for the two techniques at μ=0.0 are shown in FIGS. 7 and 8. Both techniques can give good target yields, but the simplex methodology was generally an order of magnitude more efficient than the GA.

FIG. 8 is a chart illustrating results for μ=0.0 (GA); the abscissa is the number of cost functional evaluations, and the ordinate is the noisy cost functional values for a few typical runs. The relative noise levels are 1% for phases, 2% for amplitudes, and 5% for the observations. A good quality result is obtained with the cost functional converging close to the optimum value of −0.5. When compared with the simplex methodology in FIG. 7, the GA is slower by a factor of between 5 and 10. Similar results are obtained for μ=0.001.

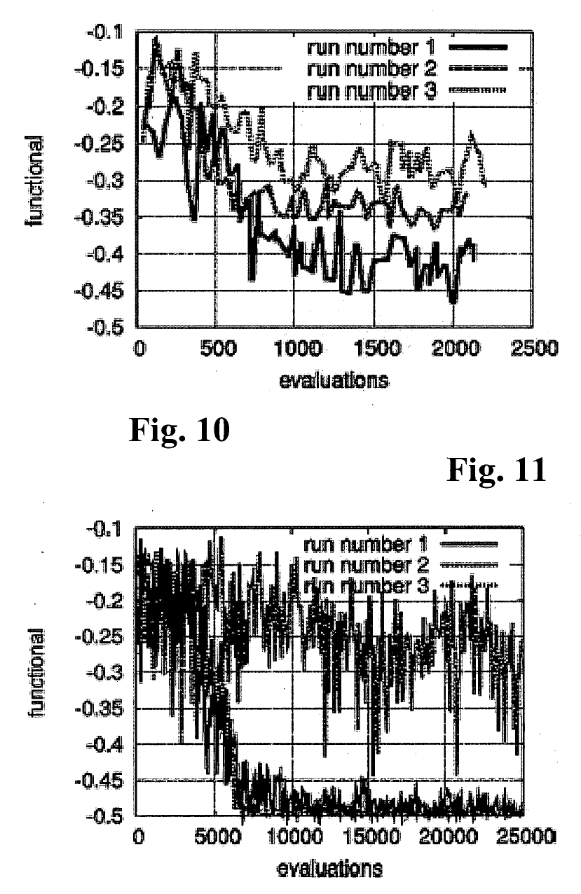

In order to test the robustness of the techniques with respect to control and observation noise levels, further numerical experiments were carried out. The parameter μ was set to zero, and the relative noise was increased by a factor of 5 to become 5% phase noise, 10% amplitude noise, and 25% observation noise. The results are given in FIGS. 10 and 11. Additional scenarios were also tested (e.g., noise levels ten times as large at 10% phase noise, 20% amplitude noise, and 50% observation noise), and the qualitative behavior was the same. The results are generally very robust to large degrees of noise, which appears consistent with analyses.

Signal averaging may generally be done in the laboratory to reduce the influence of noise. Such averaging may be effective for the observation noise, but the nonlinear influence of the control noise may still have a residual effect.

FIG. 9 is a chart illustrating the results for μ=0.1; the abscissa is the number of functional evaluations and the ordinate is the noisy cost functional values. Relative noise levels: 1% for phases, 2% for amplitudes, and 5% output noise. Because μ is high no effective control is exhibited (i.e., there is no overlap with the target and all of the techniques converge to nearly the constant zero field).

FIG. 10 is a chart illustrating the results for μ=0.0 (simplex). The abscissa is the number of functional evaluations, and the ordinate is the noisy cost functional values. The relative noise levels are 5% for phases, 10% for amplitudes, and 25% for observation.

As a conservative worst case scenario, no signal averaging was done in the present simulations. One interesting conclusion drawn from these simulations is that recomputing the cost functional value at an apparently good quality point is useful to detect faulty situations where the “good quality” is in fact due to random noise deviations. Note that the simplex methodology takes provisions against this phenomenon: for any shrink step the whole simplex is reevaluated. These arguments were at the core of the modified simplex methodology. The GA also implicitly takes into account this phenomenon if an appropriate replacement rule is chosen, for example, requiring that the parents are replaced after one generation. The influence of noise needs to be considered in examining the fluctuating values of any single functional trajectory versus the number of evaluations in the figures, especially at high noise levels.

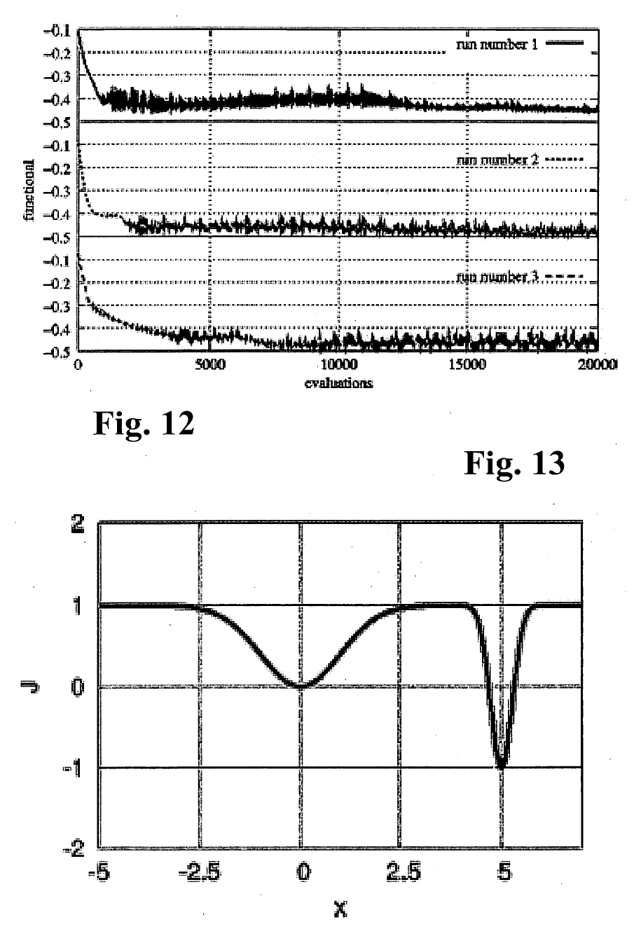

As a follow-up of the numerical results above, insight was obtained into the cost functional surface from a new technique designed to test the feasibility of generic gradient-free algorithms for optimization of quantum control cost functionals. This technique, called the Monte Carlo discrete gradient methodology, may not have been optimized for performance but rather is used to reveal some properties of the cost functional surface. The features of this search procedure are presented bellow. This technique may operate by converging to the robust solution closest to the initial point as it does not have global search properties other than those brought by the random selection of the initial point (i.e., the Monte Carlo aspect of the technique). The Monte Carlo discrete descent methodology was tested for μ=0 and zero noise level. The results are given in FIG. 12. It was found that the Monte Carlo discrete descent methodology converges to a good solution for any randomly chosen initial point. The conclusion that may be drawn from this result is that many local minima exist with values close to that of the global optimum. This behavior may not hold for general observables beyond simple projections to a single target state. This conclusion provides a possible basis to understand why the GA is less efficient than the simplex methodology in this case: since the cost functional may have many good quality minima, the global exploration properties of the GA are not needed. The GA does not have foreknowledge of this behavior and tends to explore the whole cost functional surface in the hope of finding yet a better solution, which does not exist. In contrast, the simplex methodology less thoroughly explores the cost functional surface and still finds good results because close to any initial point there is a good quality solution.

When there is no noise for μ=0 both the GA and the modified simplex methodology converge to high-quality solutions each time. However, as the GA and the simplex methodologies have known global optimization properties, this observation is less definitive about the nature of the functional surface than the conclusion drawn from the fact that the local Monte Carlo discrete descent methodology converges to a good solution for any initial point.

FIG. 11 is a chart illustrating the results for μ=0.0 (GA). The abscissa is the number of functional evaluations, and the ordinate is the noisy cost functional values. The relative noise levels are 5% for phases, 10% for amplitudes, and 25% for observation noise.

FIG. 12 is a chart illustrating results for μ=0.0 and no noise for the discrete descent methodology h=ξ=(0.01, . . . , 0.01). The abscissa is the number of functional evaluations, and the ordinate is the cost functional value. It was found that all random initial points converge to high-quality results of 90% overlap with target (this conclusion was found for many additional runs beyond those presented here). This conclusion remains partially valid as the noise level increases. The value of the cost functional for the first run increases over the period of approximately 5000 to 10 000 evaluations. This behavior arises from using the “reflection at the boundary” procedure (see Remark 3) in order to remain within predefined bounds on the controls. In this case, the minimum most close to initial (random) point is outside the chosen bounds. After a period of oscillations along the boundary the technique becomes oriented and converges toward another minimum inside the bounds.

FIG. 13 is a chart illustrating generic cost function J(x) behavior with respect to a single variable x. The minimum at x=5 is deep, but narrower than that at x=0, and may not be robust at larger scales; for example, the x=0 minimum is robust for the scale ∥h∥=2.5 but the one at x=5 is not. Both minima are robust for very small values of ∥h∥, e.g., 0.01.

Optimization techniques are a part of the experimental protocols in the laser control of quantum phenomena. The present work demonstrates through numerical simulations on selected cases that genetic algorithms (and their descendants) are not the only techniques that can perform efficiently in this context. An alternative, that is up to an order of magnitude faster (for the cases studied), is the modified simplex methodology. One possible explanation of why this latter technique is better resides in it exploiting the multiplicity of solutions and only exploring a selected region of the cost functional surface. As a by-product of the search for good optimization techniques, the present work introduced a discrete descent methodology whose convergence properties gave additional evidence that indeed the local minima of the cost functional are of very good quality.

Monte Carlo Discrete Descent Methodology

Since an exact gradient of the cost functional J(x₁, . . . , x_{N}) is not available in practice, a discrete gradient may be introduced. Let ξ=(ξ₁, . . . , ξ_{N})εR^{N} be a given vector such that ξk≠0, k=1, . . . , N. It may be denoted by eₖ the vectors of the canonical base of R^{N}: e₁=(1, 0, . . . , 0), . . . , eₖ=(0, . . . , 1, . . . , 0) e_{N}=(0 , . . . , 1), and define the discrete gradient of J(x) at the point x with respect to the increments ξ by the formula

$${∇}_{ξ}^{d} J ( x ) = ( \frac{J ( x + {ξ}_{1} {e}_{1} ) - J ( x )}{{ξ}_{1}} , … , \frac{J ( x + {ξ}_{k} {e}_{k} ) - J ( x )}{{ξ}_{k}} , … , \frac{J ( x + {ξ}_{N} {e}_{N} ) - J ( x )}{{ξ}_{N}} ) . \qquad ( A1 )$$

Note that in the limit ξ→0 the quantity thus computed is precisely the gradient of J at the point x, as each component of ∇_{ξ}^{d}J(x) converges to the corresponding partial derivative of J(x). On the other hand, if ξ is fixed it may be heuristically argued that the discrete gradient only sees details of J(x) at the scale ξ as the discrete gradient is a finite-difference representation of the true gradient at the given fixed scale ξ. This is a property which is consistent with the use of Eq. (A1), as in practice ξ is not meant to tend to zero.

Consider the increment vector h=(h, . . . , h_{N})εR^{N},ξεR^{N}. The technique is prescribed by the following steps:
(1) Choose a random point x⁰ in the admissible parameter space R^{N}; set n=0.
(2) Update the current solution by the formula

$${x}^{n + 1} = {x}^{n} - \frac{h * {∇}_{ξ}^{d} J ( {x}^{n} )}{‖ h * {∇}_{ξ}^{d} J ( {x}^{n} ) )} ‖ h ‖ , \qquad ( A2 )$$

where h*∇_{ξ}^{d}J(x^{N}) is the element-wise product of the two vectors

$$h * {∇}_{ξ}^{d} J ( {x}^{n} ) = ( {h}_{1} ( {∇}_{ξ}^{d} J {( {x}^{n} ) )}_{1} , … , {h}_{k} ( {∇}_{ξ}^{d} J {( {x}^{n} ) )}_{k} , … , {{h}_{N} ( {∇}_{ξ}^{d} J ( {x}^{n} ) )}_{N} ) , \qquad ( A3 )$$

and the “discrete gradient” ∇_{ξ}^{d}J(•) is defined in Eq. (A1).
(3) Unless a predefined stopping criterion is satisfied (e.g., an acceptable value of J(xⁿ⁺¹) is reached) set n=n+1 and return to step 2 above. Although the technique was defined here for different ξ and h, in practice ξ=h may be chosen.

In practice, in order to increase the performance of the technique above, it may be used on a population of K initial guesses x⁰₁, . . . , x⁰ₖ; thus, the K Monte Carlo discrete descent methodologies that run independently in parallel may be obtained. Note that in our implementation—and in contrast with the GA approach—there is no cross talk between the K different running members. This “Monte Carlo” label characterizes the only stochastic element present in this technique.

Except for the random initialization and the constant norm increment properties, similar techniques have been studied; related work (local linearization) is pursued. With respect to these works, the present study is different in that it is also aimed at exploring the geometry of the cost functional surface by choosing a simpler technique, except that there the step size ∥xⁿ⁺¹−xⁿ∥ can vary while here it is fixed.

Each of the K members of Monte Carlo discrete descent algorithmic search is expected to “converge” to the “robust” local optimum closest (at the scale ∥h∥) to its initial point; here, robustness means that in a neighborhood of the local optimum the values of the cost functional are still of high quality. An illustration of the concept is given in FIG. 13.

This technique can be viewed as following the path of a ball of diameter ξ and moving at the constant “ground” speed ∥h∥ on the cost function surface being minimized. The (lower bounded) speed and the nonzero diameter may tend to smooth the cost function surface.

Note from Eq. (A2), of this section, that at each iteration the distance between two consecutive points xⁿ and xⁿ⁺¹ is the constant value ∥h∥; this choice is designed for the purpose of avoiding long periods of small incremental steps to hopefully accelerate the convergence toward the solution.

If some components xₖ of the argument x are to be within predefined intervals, then these constraints are tested during the update step 2 in the definition of the technique. If (xⁿ⁺¹)ₖ does not satisfy the conditions, then the update formula is modified by a “reflection at the boundary:”
(xⁿ⁺¹)ₖ=(xⁿ)ₖ+hₖ(∇_{ξ}^{d}J(xⁿ))ₖ∥h∥/∥h*∇_{ξ}^{d}J(xⁿ))∥.

Three cases can be considered concerning the relationship between ξ and h.
(i) ∥ξ∥<∥h∥: this corresponds to having iteration steps larger than the steps used to compute the gradient (i.e., having a precise gradient that may eventually result in lower smoothness of the cost functional, for example where the first derivative of the cost functional is either not definite or very big). This corresponds to extrapolation;
(ii) ∥ξ∥>∥h∥: the opposite circumstance, corresponding to interpolation; and
(iii) ∥ξ∥=∥h∥: there is a “neighborhood” used both to compute the gradient and to advance to the next step. This is the case that is used in the computations of this disclosure. Note from h=ξ it follows that

$$h * {∇}_{h}^{d} J ( x ) = ( J ( x + {h}_{1} {e}_{1} ) - J ( x ) , … , \\ J ( x + {h}_{k} {e}_{k} ) - J ( x ) , … , J ( x + {h}_{N} {e}_{N} ) - J ( x ) ) .$$

In this case the update step can be written as follows, where the renormalization factor ρₙ is used to enforce the constant norm increment ∥xⁿ⁺¹−nⁿ∥=∥h∥=constant

$${x}^{n + 1} = {x}^{n} - {ρ}_{n} {\sum }_{k = 1}^{N} [ J ( {x}^{n} + {h}_{k} {e}_{k} ) - J ( {x}^{n} ) ] {e}_{k} ,$$

### REFERENCES

1. E. Anderson and M. Ferris, SIAM J. Optim. 11, 837 (2001).
2. A. Assion, T. Baumert, M. Bergt, T. Brixner, B. Kiefer, V. Seyfried, M. Strehle, and G. Gerber, Science 282, 919 (1998).
3. C. Bardeen, V. V. Yakovlev, K. R. Wilson, S. D. Carpenter, P. M. Weber, and W. S. Warren, Chem. Phys. Lett. 280, 151 (1997).
4. C. J. Bardeen, V. V. Yakovlev, J. A. Squier, and K. R. Wilson, J. Am. Chem. Soc. 120, 13023 (1998).
5. R. Bartels et al. Nature 406, 164 (2000).
6. R. R. Barton and J. S. J. Ivey, Manage. Sci. 42, 954 (1996).
7. T. Brixner et al., J. Mod. Opt. 50, 539 (2003).
8. C. Daniel et al., Chem. Phys. 267, 247 (2001).
9. M. Demiralp, H. Rabitz, Phys. Rev. A 47, 809 (1993).
10. M. Deng and Y. C. Ho, Automatica J. IFAC 35, 331 (1999).
11. J. M. Geremia, W. Zhu, and H. Rabitz, J. Chem. Phys. 113, 10841 (2000).
12. J. M. Geremia and H. Rabitz, Phys. Rev. Lett. 89, 263902 (2002).
13. J. M. Geremia and H. Rabitz, J. Chem. Phys. 118, 5369 (2003).
14. M. D. Girardeau, S. G. Schirmer, J. V. Leahy, R. M. Koch, Phys. Rev. A 58, 2684 (1998).
15. D. Goldberg, Genetic Algorithms in Search, Optimization, and Machine Learning (Addison-Wesley, Reading, Mass., 1989).
16. P. Gross, D. Neuhauser, and H. Rabitz, J. Chem. Phys. 98, 4557 (1993).
17. J. L. Herek et al., Nature 414, 57 (2001).
18. Y. C. Ho, R. S. Sreenivas, and P. Vakili, Discrete Event Dyn. Syst. 2, 61 (1992); URL: http://citeseer.nj.nec.com/ho96ordinal.html.
19. Y. C. Ho and M. Larson, Discrete Event Dyn. Syst. 5, 281(1995); URL:http://citeseer.nj.nec. com /ho95ordinal. html.
20. Y. C. Ho, Inform. Sci. 113, 169 (1999).
21. T. Hornung et al., Appl. Phys. B Lasers Opt. 71, 277 (2000).
22. T. Hornung, R. Meier, and M. Motzkus, Chem. Phys. Lett. 326, 445 (2000).
23. P. D. Hough, T. G. Kolda, and V. J. Torczon, SIAM J. Sci. Comput. (USA) 23, 134 (2001).
24. D. G. Humphrey and J. R. Wilson, INFORMS J. Comput. 12, 272 (2000).
25. R. S. Judson and H. Rabitz, Phys. Rev. Lett. 68, 1500 (1992).
26. M. Keijzer, J. Merelo, G. G. Romero, and M. Schoenauer, 016704-8 Evolving Objects: A General Purpose Evolutionary Computation Library, Proceedings of the 5th International Conference on Artificial Evolution, 29-31 October 2001, Université de Bourgogne, France; URL: http://eodev.sourceforge.net.
27. T. G. Kolda, R. M. Lewis, and V. Torczon, SIAM Rev. 45(3), 385 (2003).
28. J. Kunde, B. Baumann, S. Arlt, F. Morier-Genoud, U. Siegner, and U. Keller, Appl. Phys. Lett. 77, 924 (2000).
29. J. Kunde et al., J. Opt. Soc. Am. B 18, 872 (2001).
30. C. Léonard, F. Le Quéré, P. Rosmus, C. Puzzarini, and M. de Lara Castells, Phys. Chem. Chem. Phys. 2, 1117 (2000).
31. C. Leonard, G. Chambaud, P. Rosmus, S. Carter, and N. Handy, Phys. Chem. Chem. Phys. 3, 503 (2001).
32. R. J. Levis, G. M. Menkir, H. Rabitz, Science 292, 709 (2001)
33. R. M. Lewis and V. Torczon, SIAM J. Optim. 9, 1082 (1999).
34. R. M. Lewis and V. Torczon, SIAM J. Optim. 10, 917 -(2000).
35. R. M. Lewis and V. Torczon, SIAM J. Optim. 12, 1075 (2002).
36. B. Li, G. Turinici, V. Ramakhrishna, and H. Rabitz, J. Phys. Chem. B 106, 8125 (2002).
37. D. Meshulach, Y. Silberberg, Nature 396, 239 (1998).
38. B. J. Pearson, J. L. White, T. C. Weinacht, P. H. Bucksbaum, Phys. Rev. A 63, 063412 (2001).
39. M. Q. Phan and H. Rabitz, J. Chem. Phys. 110, 34 (1999).
40. W. H. Press, S. A. Teukolsky, W. T. Vetterling, and B. P. Flannery, Numerical Recipes in C++, 2nd ed. (Cambridge University Press, Cambridge, 2002).
41. H. Rabitz, R. de Vivie-Riedle, M. Motzkus, K. Kompa, Science 288, 824 (2000).
42. H. Rabitz, Phys. Rev. A 66, 063405 (2002).
43. H. Rabitz, G. Turinici, and E. Brown, in Computational Chemistry, edited by C. Le Bris, Special Volume of Handbook of Numerical Analysis, Vol. X, edited by P. G. Ciarlet (Elsevier Science, New York, 2003), pp. 833-887.
44. V. Ramakrishna, M. V. Salapaka, M. Dahleh, H. Rabitz, A. Peirce, Phys. Rev. A 51, 960 (1995).
45. S. A. Rice, M. Zhao, Optical Control of Molecular Dynamics (Wiley, N.Y., 2000).
46. M. Shapiro and P. Brumer, Acc. Chem. Res. 22, 407 (1989).
47. S. Shi, A. Woody, and H. Rabitz, J. Chem. Phys. 88, 6870 (1988).
48. V. Torczon, SIAM J. Optim. 7, 1 (1997).
49. A. Törn and A. Zilinskas, Global Optimization, Lecture Notes in Computer Science, Vol. 350 (Springer, Berlin, 1989).
50. G. Tóth, A. Lörincz, and H. Rabitz, J. Chem. Phys. 101, 3715 (1994).
51. G. Turinici, H. Rabitz, J. Phys. A Math. Gen. 36, 2565 (2003).
52. T. Weinacht, J. Ahn, and P. Bucksbaum, Nature (London) 397, 233 (1999).
53. T. Weinacht et al., Chem. Phys. Lett. 344, 333 (2001).
54. A. M. Weiner, Rev. Sci. Instrum. 71, 1929 (2000).
55. D. Zeidler, S. Frey, K. L. Kompa, M. Motzkus, Phys. Rev. A 64, 023420 (2001).
56. W. Zhu, H. Rabitz, Int. J. Quant. Chem. 93, 50 (2003).

1. A method for accelerating searches for optimal control of photonic reagents, said method comprising the steps of:
applying closed loop feedback to control a quantum system; and
using a direct search deterministic technique for refining said closed loop feedback control.

2. The method of claim 1, further comprising the steps of:
generating a shaped laser pulse;
applying said shaped laser pulse to said quantum system;
monitoring said quantum system after said shaped laser pulse is applied; and
adjusting said shaped laser pulse based on a result of said monitoring.

3. The method of claim 2, wherein frequency chirping techniques are used for generating said shaped laser pulse.

4. The method of claim 2, wherein said shaped laser pulse is applied to said quantum system to transition said quantum system from an initial quantum state to a desired final quantum state.

5. The method of claim 2, wherein said shaped laser pulse is applied to said quantum system to manipulate matter within said quantum system.

6. The method of claim 2, wherein said shaped laser pulse is applied to said quantum system to trigger selective breaking of chemical bonds.

7. The method of claim 2, wherein said shaped laser pulse is applied to said quantum system to trigger molecular vibration excitation within said quantum system.

8. The method of claim 2, wherein said shaped laser pulse is applied to said quantum system to enhance radiative high harmonics.

9. The method of claim 8, wherein said shaped laser pulse is applied to said quantum system to generate high intensity high harmonic optical sources.

10. The method of claim 2, wherein said shaped laser pulse is applied to said quantum system to implement ultrafast semiconductor optical switches.

11. The method of claim 2, wherein said shaped laser pulse is applied to said quantum system to trigger ultrafast semiconductor optical switches.

12. The method of claim 2, wherein said shaped laser pulse is applied to said quantum system to trigger an electron transfer in biological samples.

13. The method of claim 12, wherein said biological samples comprises photosynthetic antenna complexes.

14. The method of claim 2, wherein said shaped laser pulse is applied to said quantum system to create tailored excitation in molecules.

15. The method of claim 2, wherein said shaped laser pulse is applied to said quantum system to trigger tailored excitation in solid state matter.

16. The method of claim 2, wherein mass spectrometry is utilized to monitor said quantum system.

17. The method of claim 1, wherein a direct descent methodology is utilized in addition to said direct search deterministic technique to refine said closed loop feedback control.

18. The method of claim 1, wherein a discrete descent methodology is utilized in addition to said direct search deterministic technique to refine said closed loop feedback control.

19. The method of claim 18, wherein said discrete descent methodology uses a Monte Carlo technique.

20. The method of claim 1, wherein said direct search deterministic technique is guided by pattern recognition methodologies.

21. The method of claim 1, further comprising applying a closed loop learning control technique.

22. The method of claim 1, wherein said direct search deterministic technique includes applying a local search methodology.

23. The method of claim 1, wherein said direct search deterministic technique includes applying a hierarchical search methodology.

24. The method of claim 1, wherein said direct search deterministic technique includes applying ordinal optimization.

25. The method of claim 1, wherein said direct search deterministic technique includes applying a simplex methodology.

26. The method of claim 1, wherein said direct search deterministic technique includes applying a modified simplex methodology.

27. The method of claim 1, wherein said direct search deterministic technique includes applying a quasideterministic methodology.

28. The method of claim 1, wherein said direct search deterministic technique includes applying guided control over a quantum system landscape.

29. The method of claim 28, wherein said quantum system landscape is without substantial local extrema.

30. The method of claim 1, wherein said direct search deterministic technique utilizes functional evaluations for refining said closed loop feedback control.

31. The method of claim 1, wherein said direct search deterministic technique exploits a high duty cycle in refining said closed loop feedback control.

32. The method of claim 1, wherein said direct search deterministic technique has a characteristic of robustness with respect to noise.

33. The method of claim 1, wherein said direct search deterministic technique avoids being trapped in a local extremum.

34. The method of claim 1, wherein said direct search deterministic technique performs high-dimensional searches.

35. A quantum system controller for optimally controlling photonic reagents, comprising:
a closed loop feedback controller for applying closed loop feedback to control a quantum system; and
a control refining module utilizing a direct search deterministic technique to refine said closed loop feedback control.

36. The quantum system controller of claim 35, further comprising:
a monitoring device for monitoring said quantum system after a shaped laser pulse from a laser pulse source is applied to the quantum system; and
an adjustment module for adjusting said shaped laser pulse based on a result of said monitoring.

37. The quantum system controller of claim 36, wherein said quantum system controller controls said shaped laser pulse applied to said quantum system to transition said quantum system from an initial quantum state to a desired final quantum state.

38. The quantum system controller of claim 36, wherein said quantum system controller controls said shaped laser pulse applied to said quantum system to manipulate matter within said quantum system.

39. The quantum system controller of claim 36, wherein said quantum system controller controls said shaped laser pulse applied to said quantum system to trigger selective breaking of chemical bonds.

40. The quantum system controller of claim 36, wherein said quantum system controller controls said shaped laser pulse applied to said quantum system to trigger molecular vibration excitation within said quantum system.

41. The quantum system controller of claim 36, wherein said quantum system controller controls said shaped laser pulse applied to said quantum system to enhance radiative high harmonics.

42. The quantum system controller of claim 41, wherein said quantum system controller controls said shaped laser pulse applied to said quantum system to generate high intensity high harmonic optical sources.

43. The quantum system controller of claim 36, wherein said quantum system controller controls said shaped laser pulse applied to said quantum system to implement ultrafast semiconductor optical switches.

44. The quantum system controller of claim 36, wherein said quantum system controller controls said shaped laser pulse applied to said quantum system to trigger ultrafast semiconductor optical switches.

45. The quantum system controller of claim 36, wherein said quantum system controller controls said shaped laser pulse applied to said quantum system to trigger an electron transfer in biological samples.

46. The quantum system controller of claim 45, wherein said biological samples comprises photosynthetic antenna complexes.

47. The quantum system controller of claim 36, wherein said quantum system controller controls said shaped laser pulse applied to said quantum system to trigger tailored excitation in molecules.

48. The quantum system controller of claim 36, wherein said quantum system controller controls said shaped laser pulse applied to said quantum system to trigger tailored excitation in solid state matter.

49. The quantum system controller of claim 36, wherein said monitoring device includes a mass spectrometer.

50. The quantum system controller of claim 35, wherein said control refining module uses random values in said direct search deterministic technique for refining said closed loop feedback control.

51. The quantum system controller of claim 35, wherein said control refining module utilizes a direct descent methodology in addition to said direct search deterministic techniques to refine said closed loop feedback control.

52. The quantum system controller of claim 35, wherein said control refining module utilizes a discrete descent methodology in addition to said direct search deterministic technique to refine said closed loop feedback control.

53. The quantum system controller of claim 52, wherein said discrete descent methodology uses a Monte Carlo technique.

54. The quantum system controller of claim 35, wherein said control refining module utilizes pattern recognition methodologies to guide said direct search deterministic technique.

55. The quantum system controller of claim 35, wherein said control refining module applies closed loop learning control technique.

56. The quantum system controller of claim 35, wherein said control refining module applies a local search methodology in said direct search deterministic technique.

57. The quantum system controller of claim 35, wherein said control refining module applies a hierarchical search methodology in said direct search deterministic technique.

58. The quantum system controller of claim 35, wherein said control refining module applies ordinal optimization in said direct search deterministic technique.

59. The quantum system controller of claim 35, wherein said control refining module applies a simplex methodology in said direct search deterministic technique.

60. The quantum system controller of claim 35, wherein said control refining module applies a modified simplex methodology in said direct search deterministic technique.

61. The quantum system controller of claim 35, wherein said control refining module applies a quasideterministic methodology in said direct search deterministic technique.

62. The quantum system controller of claim 35, wherein said quantum system controller performs guided control over a quantum system landscape methodology.

63. The quantum system controller of claim 35, wherein said control refining module utilizes functional evaluations for refining said closed loop feedback control.

64. A mass spectrometer including the quantum system controller of claim 35.

65. A quantum dynamic discriminator for analyzing a composition, said quantum dynamic discriminator including the quantum system controller of claim 35.

66. A sample identification system for ascertaining the identity of at least one component in a composition, said sample identification system including the quantum system controller of claim 35.

67. A sample identification system for ascertaining an identifying characteristic of at least one component in a composition, said sample identification system including the quantum system controller of claim 35.

68. A device for ascertaining the molecular structure of a quantum system, said device including the quantum system controller of claim 35.

69. An optimal identification device for ascertaining the quantum Hamiltonian of said quantum system, said optimal identification device including the quantum system controller of claim 35.

70. A computer system comprising:
a processor; and
a program storage device readable by the computer system, tangibly embodying a program of instructions executable by the processor to perform the method claimed in claim 1.

71. A program storage device readable by a machine, tangibly embodying a program of instructions executable by the machine to perform the method claimed in claim 1.

72. A computer data signal transmitted in one or more segments in a transmission medium which embodies instructions executable by a computer to perform the method claimed in claim 1.
